(19) United States
(12) Patent Application Publication
(10) Pub. No.: US 2012/0033806 A1
(43) Pub. Date: Feb. 9, 2012

(54) METHOD OF ENCRYPTING A DATA STREAM

(75) Inventors: Guido Bertoni, Carnate (IT); Fabio Sozzani, Grenoble (FR)

(73) Assignees: STMICROELECTRONICS S.R.L., Agrate Brianza (IT); STMICROELECTRONICS (GRENOBLE 2) SAS, Grenoble (FR)

(21) Appl. No.: 13/196,568

(22) Filed: Aug. 2, 2011

(30) Foreign Application Priority Data
Aug. 4, 2010 (FR) 10 03269

(51) Int. Cl. H04L 9/18

(52) U.S. Cl. 380/42

(57) ABSTRACT

The disclosure relates to a method of encrypting or of decrypting a binary data stream by generating a binary encryption stream and combining by a reversible logic operation each bit of the binary data stream with a bit of the binary encryption stream, the generation of the binary encryption stream including generating an input block by applying a cryptographic function using a secret key to a data block, and generating the binary encryption stream from the input block by combining the bits of the input block with each other by logic operations in a manner so as to prevent the input block from being determined from the binary encryption stream.

### BACKGROUND

1. Technical Field

The present disclosure relates to the protection of data transmitted in the form of a binary stream or by a bus.

2. Description of the Related Art

The protection of digital data is generally done by encrypting these data before transmitting them, such that only the addressee of the data, who possesses an appropriate secret key, can decrypt the encrypted data in order to access the emitted data.

Presently, an increase of both the required data transmission rates and security level, that is to say, in particular the robustness of the cryptographic algorithms that may be used may be observed. It results that the calculation power necessary to perform such encryption and decryption operations tends to increase in an exponential manner.

Block encryption methods (“Block Cipher”) exist that generally offer a high robustness but require significant calculation means or long calculation times that may be incompatible with some desired transmission rates.

Stream encryption methods (“Stream Cipher”) also exist wherein each bit of a bit stream is combined by a reversible logic operation, such as an Exclusive OR, with a bit of a pseudo-random encryption bit stream that is continuously generated as data to transmit arrive. These methods are adapted to the processing of binary streams having high rates, and generally do not require significant calculation means. Nevertheless, these methods have a lower robustness than block encryption methods. The document “Dismantling SecureMemory, CryptoMemory and CryptoRF” by Flavio D. Garcia, Peter van Rossum, Roel Verdult, Ronny Wichers Schreur; Institute for Computing and Information Sciences; Radboud University; Nijmegen, The Netherlands; dated Mar. 30, 2010, describes a stream encryption method and a method of attacking this encryption method.

### BRIEF SUMMARY

The present disclosure relates to the protection of data transmitted in the form of a binary stream or by a bus. The inventors have realized it may be desired to have an encryption method that is both robust and compatible with high transmission rates, such as those encountered in the digital television domain, all while implementing calculation means with a cost compatible for the general public.

Embodiments may be applied, but not exclusively, to mobile telephony, to the transmission of digital television signals, and to the transmission of data within an integrated circuit. More generally, embodiments may be used in connection with sensitive digital data transmissions, that is to say data needing to be protected against unauthorized third party access. Thus, an embodiment may apply to paying services, such as pay-per-view television, electronic commerce, or administrative services involving the transmission of confidential data.

Embodiments may relate to a method of encrypting or of decrypting a binary data stream, comprising steps of a generating a binary encryption stream and of combining by a reversible logic operation each bit of the binary data stream with a bit of the binary encryption stream; wherein the generation of the binary encryption stream comprises steps of generating an input block by applying a cryptographic function using a secret key to a data block, and generating the binary encryption stream from the input block by combining the bits of the input block with each other by logic operations in a manner so as to prevent the input block from being determined from the binary encryption stream only.

According to one embodiment, the method comprises steps of successively generating input blocks by applying the cryptographic function to an input block previously obtained.

According to one embodiment, the generation of the binary encryption stream is done by cycles during each of which several bits of the binary encryption stream are generated, the generation of an input block having a duration equal to several tens of generation cycles of the binary encryption stream.

According to one embodiment, an initial data block is randomly generated, used to generate a first data block by application of the cryptographic function, and transmitted by a data stream emitter to a data stream receiver.

According to one embodiment, the generation of the binary encryption stream is done in cycles, each comprising steps of combining several bits of the input block with each other to generate several bits of the encryption stream, and of updating a part of the input block by combining several bits of the input block with each other, in a manner such that following a certain number of cycles, each bit of the input block depends from all the bits of an initial input block.

According to one embodiment, the cryptographic function is of the type Advanced Encryption Standard (AES), Data Encryption Standard (DES), Triple DES, Twofish, Serpent, etc., or else a hashing function applied to the data to encrypt and to the secret key.

Embodiments also may relate to a stream encryption device comprising a generation circuit of a binary encryption stream and a reversible combinational logic circuit of each bit of a data stream to encrypt or to decrypt with a bit of the binary encryption stream, wherein the generation circuit comprises a block encryption circuit to generate an input block, and a combinational logic circuit of bits of the input block, supplying the binary encryption stream from the input block, the circuit implementing the method according to one of the embodiments disclosed above.

According to one embodiment, the combinational logic circuit comprises a supply logic circuit to generate bits of the binary encryption stream as a function of bits of the input block, and an update logic circuit to combine bits of the input block and to replace bits of the input block with bits resulting from the combination.

According to one embodiment, the update logic circuit is configured so that each bit of the updated input block depends on all the bits of the input block supplied by the block encryption circuit, after a certain number of processing cycles of the update logic circuit.

According to one embodiment, the combinational logic circuit comprises a block shift register receiving the encrypted block which is shifted at each processing cycle of the combinational logic circuit a number of bits equal to a number of bits of the binary encryption stream supplied at each processing cycle of the combinational logic circuit, and logic gates to supply the bits of the binary encryption stream by combining several bits of the shift register.

According to one embodiment, the combinational logic circuit comprises a block shift register receiving the encrypted block that is shifted, at each processing cycle of the combinational logic circuit, a number of bits equal to a number of bits of the binary encryption stream supplied at each processing cycle of the combinational logic circuit, and non-linear logic circuits to combine bits of the shift register and to introduce bits obtained by the non-linear logic circuits in the shift register.

According to one embodiment, the non-linear logic circuits each comprise several word inputs each receiving a word of the block shift register, several word shift registers by word input, to rotate the bits of a word input upon themselves by a certain number of bits, several combinational logic functions to combine between each other bits of several words contained in a word shift register, and each supplying a word, and logic gates to combine the bits of words output from combinational logic functions with each other and to supply an output word that is introduced in the block shift register.

According to one embodiment, the combinational logic circuit is configured to supply bits of the binary encryption stream at each of the cycles of a clock signal clocking the combinational logic circuit.

According to one embodiment, the combinational logic circuit comprises a block shift register receiving the encrypted block that is shifted at each of the cycles of a clock signal clocking the combinational logic circuit, the combinational logic circuit being configured to update at least a part of the block shift register at each cycle of the clock signal by using as large a part as possible of the block shift register without penalizing the clock cycle durations.

In an embodiment, a method comprises: encrypting or decrypting a binary data stream by, applying a cryptographic function using a secret key to a data block to generate an encryption input block; logically combining bits of the encryption input block to generate a binary encryption stream, wherein the encryption input block in not determinable solely from the binary encryption stream; and applying a reversible logic operation to combine each bit of the binary data stream with a bit of the binary encryption stream. In an embodiment, the method comprises generating a successive encryption input block by applying the cryptographic function to the encryption input block previously obtained. In an embodiment, the generation of the binary encryption stream is done in cycles during each of which several bits of the binary encryption stream are generated, the generation of encryption input blocks having a duration equal to at least twenty generation cycles of the binary encryption stream. In an embodiment, the duration is equal to at least thirty generation cycles of the binary encryption stream. In an embodiment, an initial data block is: randomly generated; used to generate a first data block by application of the cryptographic function; and transmitted by a data stream emitter to a data stream receiver. In an embodiment, the generation of the binary encryption stream is done in cycles, each comprising combining several bits of the encryption input block to generate several bits of the binary encryption stream, and of updating a part of the encryption input block by combining several bits of the encryption input block, wherein after a number of cycles, each bit of the encryption input block depends from all the bits of an initial encryption input block. In an embodiment, the cryptographic function is selected from one of an advanced encryption standard (AES), a data encryption standard (DES), a Triple DES, a Twofish function, a Serpent function, and a hashing function, applied to the data block and to the secret key.

In an embodiment, a device comprises: an encryption binary stream generator having: an encryption block generator configured to generate an encryption input block from a data block using a secret key; and combinational logic configured to generate a binary encryption stream from bits of the encryption input block, wherein the encryption input block is not determinable solely from the binary encryption stream; and logic configured to combine bits of the binary encryption stream with respective bits of a binary data stream. In an embodiment, the logic configured to combine bits of the binary encryption stream with respective bits of the binary data stream is configured to: in a first mode of operation, encrypt the binary data stream; and in a second mode of operation, decrypt the binary data stream. In an embodiment, the combinational logic comprises supply logic configured to generate bits of the binary encryption stream as a function of bits of the encryption input block, and update logic configured to combine bits of the encryption input block and to replace bits of the encryption input block with bits resulting from the combination. In an embodiment, the update logic is configured so that after a number of processing cycles of the update logic, each bit of an updated encryption input block depends on all the bits of the encryption input block supplied by the encryption block generator. In an embodiment, the combinational logic comprises: a block shift register configured to shift the encryption input block at each processing cycle of the combinational logic a number of bits equal to a number of bits of the binary encryption stream supplied at each processing cycle of the combinational logic; and logic gates configured to generate bits of the binary encryption stream by combining several output bits of the shift register. In an embodiment, the combinational logic comprises: a block shift register configured to shift the encryption input block at each processing cycle of the combinational logic a number of bits equal to a number of bits of the binary encryption stream supplied at each processing cycle of the combinational logic; and non-linear logic configured to combine output bits of the block shift register and to introduce bits obtained by the non-linear logic in the block shift register. In an embodiment, the non-linear logic comprises: a plurality of word shift registers configured to shift bits in words output by the block shift register; a plurality of logic blocks each coupled to a plurality of outputs of the plurality of word shift registers; and logic configured to combine outputs of the plurality of logic blocks to generate an output word that is introduced in the block shift register. In an embodiment, the combinational logic is configured to supply bits of the binary encryption stream at each of the cycles of a clock signal driving the combinational logic. In an embodiment, the combinational logic comprises a block shift register configured to shift the encryption input block at each of cycle of a clock signal driving the combinational logic, the combinational logic being configured to update at least a part of the block shift register at each cycle of the clock signal.

In an embodiment, a system comprises: a plurality of devices, each having: a encryption block generator configured to generate an encryption input block from a data block using a secret key; combinational logic configured to generate a binary encryption stream from bits of the encryption input block, wherein the encryption input block is not determinable solely from the binary encryption stream; and logic configured to combine bits of the binary encryption stream with respective bits of a binary data stream; and a data link configured to communicatively couple the plurality of devices. In an embodiment, the combinational logic comprises an encryption input block shift register. In an embodiment, the logic configured to combine bits of the binary encryption stream with respective bits of the binary data stream is configured to: in a first mode of operation, encrypt the binary data stream; and in a second mode of operation, decrypt the binary data stream. In an embodiment, a device comprises: means for generating an encryption input block from a data block; means for generating a binary encryption stream from the encryption input block so that the encryption input block in not determinable solely from the binary encryption stream; and means for combining each bit of a binary data stream with a bit of the binary encryption stream. In an embodiment, the device comprises means for generating successive encryption input blocks from an encryption input block previously obtained. In an embodiment, the means for generating the encryption input block is configured to apply to the data block a cryptographic function selected from one of an advanced encryption standard (AES), a data encryption standard (DES), a Triple DES, a Twofish function, a Serpent function, and a hashing function.

### BRIEF DESCRIPTION OF THE SEVERAL VIEWS OF THE DRAWINGS

Embodiment will be described by way of example and in a non-limiting manner, in relation with the appended drawings among which:

FIG. 1 schematically shows two devices in communication, implementing an encryption device,

FIG. 2 schematically shows an encryption device according to an embodiment,

FIG. 3 schematically shows sequences of steps of an embodiment of a method of generating binary encryption streams for the two devices of FIG. 1,

FIG. 4 schematically shows a functioning mode of an embodiment of an encryption device,

FIG. 5 schematically shows a circuit of an encryption device, according to an embodiment,

FIG. 6 is an example of an electrical diagram of an encryption device, according to an embodiment, and

FIG. 7 is an example of an electrical diagram of a circuit of an encryption device, according to an embodiment.

### DETAILED DESCRIPTION

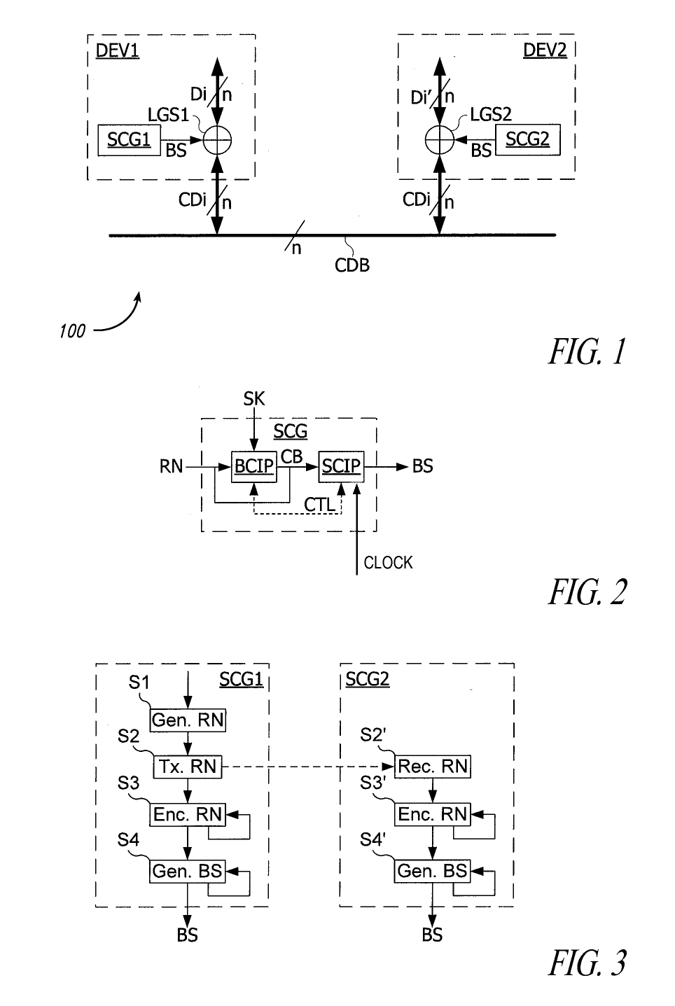

FIG. 1 shows an embodiment of a system 100 having two devices DEV1, DEV2 in communication with each other by the intermediary of a data link CDB. To secure the transmitted data, each of the two devices is linked to link CDB by the intermediary of a logic circuit LGS1, LGS2. Each of logic circuits LGS1, LGS2 also receives one or several binary encryption streams BS of an encryption stream generation circuit SCG1, SCG2. Each of logic circuits LGS1, LGS2 combines a binary data stream emitted by one of devices DEV1, DEV2 and received by the other of devices DEV1, DEV2, with a binary encryption stream BS.

Communication link CDB may comprise a digital bus of one or n wires and/or a wireless transmission link, such as a WiFi link or equivalent. Each of logic circuits LGS1, LGS2 may comprise one or more logic gates, for example according to the number of binary streams in parallel to process on output of devices DEV1, DEV2. Thus, when device DEV1 emits a bit of data Di, circuit LGS1 transmits a bit of encrypted data CDi to link CDB, such that CDi=LO(Di, BSi), LO being a logic operation applied by circuit LGS1 to the bit of data Di and to a corresponding bit BSi of binary encryption stream BS generated by circuit SCG1, SCG2. Operation LO is reversible, that is to say, a complementary operation LO′ exists that allows an encrypted bit CDi to be decrypted to obtain the corresponding bit of data Di from bit CDi and from bit BSi which was used to obtain bit CDi:Di=LO′(CDi, BSi). Complementary operation LO′ is implemented by circuit LGS2 to decrypt the received binary stream. Each bit of encrypted data CDi is transmitted by link CDB and received by circuit LGS2, which applies to it operation LO′ by using the same bit BSi of the binary encryption stream generated by circuit LGS2 in the same manner as circuit LGS1. Thus, logic operation LO is for example an Exclusive OR operation. In this case, operations LO and LO′ are identical because CDi⊕BSi=(Di⊕BSi)⊕BSi=Di⊕(BSi⊕BSi)=Di⊕0=Di, “⊕” being the Exclusive OR operator.

To decrypt the data received from device DEV1, circuit LGS2 thus generates the same binary decryption stream as that used for encrypting these data.

FIG. 2 shows an embodiment of the encryption stream generation circuits SCG1, SCG2. In FIG. 2, circuit SCG comprises a block encryption circuit BCIP and a combinational logic circuit SCIP. Circuit BCIP comprises a block input of data to encrypt, a secret key SK input, and an encrypted data CB block output connected to the block encryption input of circuit BCIP and to an input of circuit SCIP. Circuit BCIP applies a cryptographic function to the block of data supplied on input and supplies on output a block of encrypted data CB. Circuit SCIP generates binary encryption stream BS by combining encrypted block bits CB supplied by circuit BCIP. Circuit SCIP and circuit BCIP exchange control and synchronization signals CTL, for example to manage the access to a communication interface between circuits BCIP and SCIP. During a first iteration, circuit BCIP receives on the block encryption input a number RN that may be randomly generated. During several following iterations, the block encryption input of circuit BCIP receives a previously-generated encrypted block. Circuit BCIP implements for example a symmetric block encryption function, such as AES (Advanced Encryption Standard), DES (Data Encryption Standard), Triple DES, Twofish, Serpent, etc. Circuit BCIP may implement a hashing function applied to the data to encrypt and to secret key SK, such as MD5 (Message Digest 5), SHA-1, SHA-2 (Secure Hash Algorithm), etc. The circuit SCIP is driven by a clock signal CLOCK having a frequency FC.

So that circuit SCG2 may generate binary encryption stream BS used to encrypt the data received from circuit LGS1, circuit SCG2 knows random number RN, and shares secret key SK with circuit SCG1. Random number RN may be transmitted from circuit LGS1 to circuit LGS2 by any means, and it is not necessary that this transmission be secure.

The architecture shown in FIGS. 1 and 2 has the advantage that it is possible to employ only one block encryption calculation circuit per encrypted data emitting and/or receiving device. It may be noted that circuits SGC1, SGC2 as illustrated do not comprise separate block decryption circuits performing a processing inverse of that of circuit BCIP.

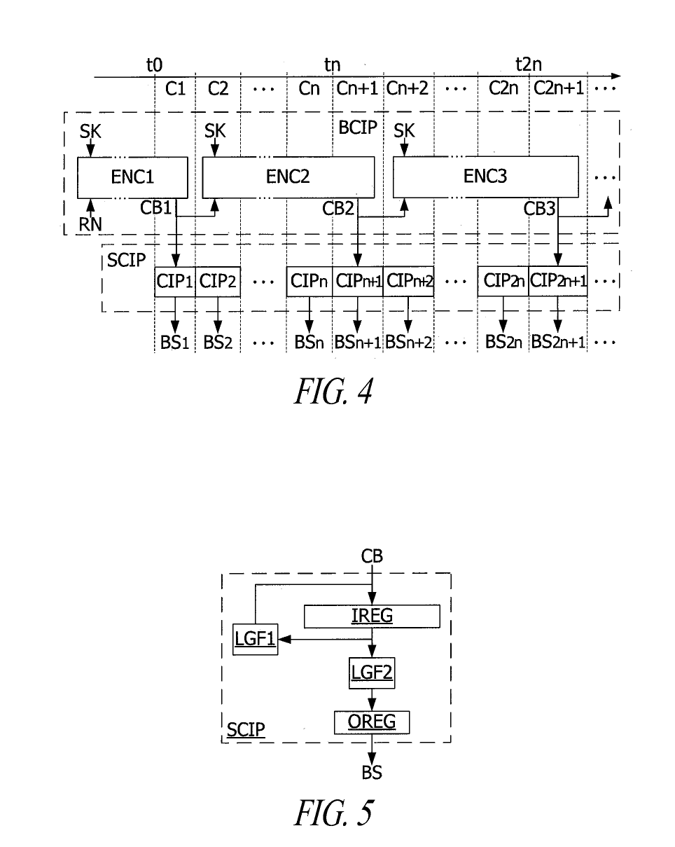

FIG. 3 shows sequences of steps executed by encryption stream generation circuits SCG1, SCG2 when device DEV1 associated with circuit SCG1 sends data to device DEV2 associated with circuit SCG2. Circuit SCG1 executes steps S1 to S4, while circuit SCG2 executes steps S2′ to S4′. At step S1, circuit SCG1 generates a random number RN. At step S2, circuit SCG1 sends number RN to device DEV2. At step S2′, circuit SCG2 receives number RN. At step S3, circuit BCIP of circuit SCG1 encrypts number RN to obtain an encrypted block CB, and repeats this operation a certain number of times from the last obtained encrypted block to obtain a new encrypted block. Circuit SCG1 transmits each encrypted block CB obtained to circuit SCIP of circuit SCG1. At step S4, circuit SCIP of circuit SCG1 generates bits of a binary stream BS from the last encrypted block CB transmitted by circuit BCIP. Step S4 is executed as many times as necessary to generate a binary encryption stream corresponding to the size of the binary data stream to encrypt. In parallel, following step S2′, circuit SCG2 executes steps S3′ and S4′, analog to steps S3 and S4, as many times as necessary from number RN received to generate a binary stream identical to binary stream BS generated by circuit SCG1.

FIG. 4 shows the functioning of each of circuits SCG1, SCG2 to generate stream BS. During a first encryption calculation ENC1, circuit BCIP generates a first encrypted block CB1 from a number RN, for example randomly generated, and from secret key SK supplied on input. Block CB1 is supplied on input (in the place of number RN) of a second encryption calculation ENC2 done by circuit BCIP. In parallel, block CB1 is supplied to circuit SCIP, which launches at moment tO a series of generation cycles C1, C2, C3, . . . Cn of bits of a binary encryption stream BS. At each cycle C1 . . . Cn, circuit SCIP does a bit generation operation of binary stream CIP1, CIP2, CIP3, . . . CIPn to generate one or more bits BS1, BS2, BS3, . . . BSn of binary stream BS. Following n cycles C1 . . . Cn, at an instant tn, block encryption calculation ENC2 finishes and supplies a second encrypted block CB2 to circuit SCIP and on input of circuit BCIP for a third block encryption calculation ENC3. Thus, circuit SCIP functions in an autonomous manner during these n cycles. During calculation ENC3, circuit SCIP performs from moment tn, for each of following n cycles Cn+1, . . . , C2n a bit generation operation of binary stream CIPn+1, . . . CIP2n supplying bits BSn+1, . . . BS2n from encrypted block CB2. At the following cycle C2n+1 starting at moment t2n, calculation ENC3 supplies an encrypted block CB3 that is used during n cycles from cycle C2n+1 to generate bit encryption streams BS2n+1 . . . At each calculation ENC1, ENC2, ENC3, . . . , the same key SK is used. Moreover, after a certain number of successive encryption calculations done by circuit BCIP from a number RN, a new number RN may be generated and transmitted to circuit BCIP and to circuit SCG2.

The two circuits BCIP and SCIP may function at different clock frequencies. Thus, a clock frequency FB of circuit BCIP; a number LB of clock cycles of circuit BCIP necessary to supply an encrypted block CB; a clock frequency FC of circuit SCIP; and a minimum number TR of clock cycles of circuit SCIP necessary for circuit BCIP to generate an encrypted block CB or during which circuit SCIP functions in an autonomous manner, may be calculated thanks to the following equation:

TR=LB×FC/FB (1)

As an example, if frequencies FB and FC are of 100 MHz and 400 MHz, and if the supply of a block CB requires 15 clock cycles of circuit BCIP, the minimum number TR of cycles is equal to 60 cycles. If the size of a block CB is 128 bits and circuit SCIP supplies 32 bits of binary encryption stream BS at each clock cycle of circuit SCIP, circuit BCIP supplies approximately 853 Mbits/s, whereas circuit SCIP supplies 12.8 Gbits/s. Typically, the duration of a processing cycle of circuit SCIP is such that several tens of processing cycles Ci may occur during the generation processing of an encrypted block CB. It results that the described process, based on a combination of a block encryption and a generation of a binary encryption stream applied to encrypted blocks supplied by the block encryption, is well-adapted to supply a binary encryption stream at a high frequency.

It is to be noted that the encrypted block supplied on input of circuit BCIP at the start of an iteration following a first iteration is not necessarily the last block encrypted by circuit BCIP, but may be more generally a block previously generated by circuit BCIP.

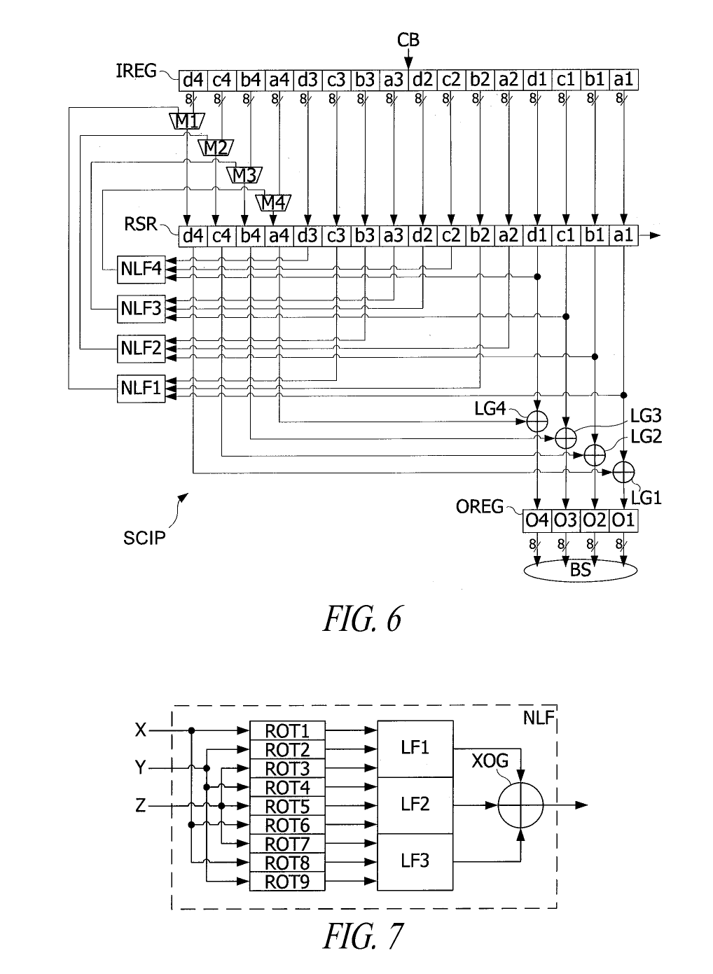

FIG. 5 shows circuit SCIP according to an embodiment. Circuit SCIP comprises an input register IREG, an output register OREG, a logic circuit LGF1 implementing an update function of register IREG at each functioning cycle of circuit SCIP, and a logic circuit LGF2 that generates at each processing cycle of circuit SCIP, a part of binary encryption stream BS in register OREG, as a function of the contents of register IREG.

Circuit SCIP is configured to prevent the binary encryption stream from being determined from other data. To this end, circuit LGF2 is configured to prevent the contents of input register IREG from being determined from the contents of output register OREG, even by analyzing the contents of register OREG over several cycles. Circuit SCIP may equally be configured to satisfy the following conditions:

reducing a size of the input register IREG (for example, keeping the size as small as possible),

circuit LGF2 is configured to supply bits of binary encryption stream BS to each clock cycle of circuit SCIP,

circuit LGF1 is configured to update at least a part of register IREG at each cock cycle of circuit SCIP, for example by using a part as large as possible of register IREG without penalizing the clock cycle durations of circuit SCIP. Indeed, in general the larger the updated part of register IREG, the bigger circuit SCIP, and therefore the longer the interconnections between the different parts of the circuit, imposing long transmission times. In an embodiment, the rate of binary encryption stream BS should be compatible with the rate of the transmission to encrypt (or to decrypt), the rate of binary stream BS being equal to the duration of processing cycles of circuit SCIP, multiplied by the number of bits in output register OREG.

FIG. 6 shows a realization example of circuit SCIP. Circuit SCIP comprises an input register IREG, a shift register RSR, four multiplexors M1, M2, M3, M4, four logic circuits NLF1, NLF2, NLF3, NLF4 performing a non-linear logic function, four basic logic gates LG1, LG2, LG3, LG4 and an output register OREG. Register IREG is dimensioned to receive at least part of an encrypted block CB coming from circuit BCIP. Shift register RSR has the same size as register IREG.

In the example of FIG. 6, register IREG comprises 16 memory units of n bits each, divided into 4 blocks of 4 units, each block i assembling units ai, bi, ci, and di (i from 1 to 4). Register RSR has a structure analogous to that of register IREG, with four blocks of four memory units of n bits. Registers IREG and RSR may also each receive a block of 16×n bits. Each of the memory units of blocks 1 to 3 of register IREG is connected to respective cells of register RSR. Units a4, b4, c4, d4 of block 4 are linked to respective cells of register RSR by the intermediary of multiplexors M1, M2, M3, M4. Each of cells a1, b1, c1, d1 of block 1 of register RSR is connected to an input of one of circuits LG1, LG2, LG3, LG4. Each of cells a4, b4, c4, d4 of block 4 of register RSR is connected to another input of one of circuits LG1, LG2, LG3, LG4. Each of circuits NLF1, NLF2, NLF3, NLF4 is connected on input to three memory units of register RSR respectively split among blocks 1, 2, and 3. Thus, in the example of FIG. 6, circuit NLF1 is connected on input to units a1, b2, and c3. Circuit NLF2 is connected on input to units b1, a2, and b3. Circuit NLF3 is connected on input to units c1, d2, and a3. Circuit NLF4 is connected on input to units d1, c2, and d3. The output of each of circuits NLFi (i may have any of values 1 to 4) is connected to an input of multiplexer Mi. Register OREG comprises 4 memory units O1, O2, O3, O4 of n bits. The output of each of circuits LG1, LG2, LG3, LG4 is connected to a unit O1, O2, O3, O4 of output register OREG. Circuits LG1 to LG4 apply for example an Exclusive OR logic operation bit-by-bit to words in register RSR.

At each clock cycle, circuit SCIP therefore supplies 4×n bits of binary encryption stream BS. If n is equal to 8, registers IREG and RSR may each receive 128 bits and register OREG 32 bits. At the first processing cycle of circuit SCIP, register IREG receives an encrypted block CB from circuit BCIP. Multiplexors M1 to M4 are controlled to integrally transfer block CB in register RSR. The contents of register RSR are transferred to circuits NLF1 to NLF4 and LG1 to LG4, and circuits LG1 to LG4 combine the first and the fourth block a1, b1, c1, d1 and a4, b4, c4, d4 of register RSR, and transfer the results in register OREG. At the end of the first cycle, unit O1 of register OREG contains the words of units a1 and d4 combined, unit O2 contains the words of units b1 and c4 combined, unit O3 contains the words of units c1 and b4 combined, and unit O4 contains the words of units d1 and a4 combined. At the second cycle, register RSR is shifted towards the right by 4 units of n bits. The words in units a1 to d1 are therefore replaced in register RSR by the words of units a2 to d2. The words of units a2 to d2 are replaced by the words of units a3 to d3, and the words of units a3 to d3 are replaced by the words of units a4 to d4. Moreover, units a4 to d4 receive the words on output of circuits NLF1 to NLF4. Output register OREG receives therefore the words of units a1 to d1 which were initially known in units a2 to d2, each combined with a word contained in units a4 to d4, issued from circuits NLF1 to NLF4.

The presence of circuits LG1 to LG4 recombining bits of words of input register IREG prevents the contents of input register IREG from being determined from the contents of output register OREG only, even over several cycles. Indeed, in the operation x⊕y where “⊕” represents the Exclusive OR logic operator, the probabilities that each operand x, y be at 0 and 1, for a given operation result, are identical. It is therefore impossible to determine the respective values of the operands from the sole result. The operation result only allows whether the operands are identical or not to be determined. Yet it is only during the first processing cycle of circuit SCIP that the bits of binary encryption stream BS on output of register OREG result from a bit-by-bit combination of register IREG by a logic operation such as Exclusive OR. The knowledge of the architecture of circuit SCIP and of the 4×n first bits of binary stream BS only allows whether each bit of the four first words a1 . . . d1 of register IREG are identical or different from bits of the four last words a4 . . . d4 of input register IREG to be determined.

It should be noted that register IREG is optional and can be omitted in some embodiments because register RSR also receives each block CB supplied by circuit BCIP, and it is not necessary to save a block CB during the calculation done by circuit BCIP to supply a new block.

In one embodiment, circuits NLF1 to NLF4 are all identical to a circuit NLF. FIG. 7 shows a realization example of circuit NLF. Circuit NLF comprises three word inputs X, Y, Z, nine shift registers ROT1 to ROT9, three logic functions LF1, LF2, LF3 and a combinational circuit XOG. Word X is supplied to registers ROT1, ROT6 and ROT8. Word Y is supplied to registers ROT2, ROT4 and ROT9, and word Z is supplied to registers ROT3, ROT5 and ROT7. Shift registers ROT1 to ROT9 are configured to apply a binary rotation of a certain number of bits to a word X, Y or Z on input of circuit NLF. The known words in registers ROT1, ROT2, ROT3 are supplied to function LF1. The words known in registers ROT4, ROT5, ROT6 are supplied to function LF2. The words known in registers ROT7, ROT8, ROT9 are supplied to function LF3. Combinational circuit XOG receives the words on output of functions LF1, LF2 and LF3 and combines them to supply a word on output of circuit NLF.

Circuit NLF thus performs the non-linear logic operation:

F(X<<rot1,Y<<rot2,Z<<rot3)⊕F(Y<<rot4,Z<<rot5,X<<rot6)⊕F(Z<<rot7,X<<rot8,Y<<rot9) (1)

wherein F is the logic function implemented by functions LF1, LF2, LF3, “<<” is the rotation operator of bits of a word, and “⊕” is the combinational logic operation implemented by circuit XOG, which is for example the Exclusive OR logic operation applied bit-by-bit to bits of input words. The bit rotations by registers ROT1 to ROT9 connected to a same function LF1, LF2, LF3 may be different. Similarly, the rotations by registers ROT1 to ROT9 that receive a same input word X, Y, Z may also be different. Functions LF1, LF2, LF3 may be different or identical. Logic function F may be a non-linear function of a degree greater than or equal to 2, knowing that the combination of logic operators AND, OR, or Exclusive OR perform a degree 2 non-linear function. Logic function F is for example one of following functions:

F((X,Y,Z))=(X·Y)+( X̅·Z) (2)

F((X,Y,Z))=(X·Z)+(Y· Z̅) (3)

F((X,Y,Z))=Y⊕(X+ Z̅) (4)

wherein “·” represents logic operator AND, “+” represents logic operator OR, “⊕” represents logic operator Exclusive OR, and “ x̅” represents logic operator NOT(x). More generally, function F may be chosen in a manner such that the non-linearity of the function is not compensated as it is applied to words of register RSR at each processing cycle of circuit SCIP. Indeed, for certain functions F, certain words of register RSR may, after several processing cycles of circuit SCIP, only depend on a limited number of words initially introduced in register RSR from register IREG. Thus, instead of being extended, the non-linearity is thereby restrained.

More generally, the function implemented by circuits NLF1 to NLF4 may be chosen in a manner so as to maximize the number of bits of register IREG upon which a bit of register RSR depends at a given processing cycle of circuit SCIP, and to maximize the number of bits of register RSR at a given processing cycle, upon which each bit of register IREG depends, it being given that these numbers increase in an exponential manner at each processing cycle until a maximum is reached.

Thus, in the example described above of circuit SCIP, each word issued by circuits NLF1 to NLF4 depends on three words of register RSR, and in the example of circuit NLF, each bit of the output word of the circuit depends on nine bits of input words, if the previously described conditions for rotations ROT1 to ROT9 are met. It may also be shown that in the example of FIGS. 6 and 7, each bit of register RSR depends on all the bits of register IREG after only 15 processing cycles of circuit SCIP, and each bit of register IREG is used in all the bits of register RSR after only 16 iterations.

It will clearly appear to the skilled person that the present disclosure is susceptible of diverse realization embodiments and applications. In particular, the disclosure is not limited to the examples previously described, but may be done by any circuit combining a block encryption circuit supplying an encrypted block CB and a logic circuit combining bits of encrypted block CB in a manner so as to generate a binary stream BS, when the binary stream BS supplied itself does not allow the block on output of the block encryption circuit to be determined.

Moreover, the generation of several blocks encrypted using a previously-generated encrypted block may not be necessary. Indeed, as previously described, the encryption stream generation logic circuit may function in an autonomous manner from a block encrypted over numerous cycles. The generation of new encrypted blocks influences the robustness of the encryption method by resulting stream.

Some embodiments may take the form of computer program products. For example, according to one embodiment there is provided a computer readable medium comprising a computer program adapted to perform one or more of the methods described above. The medium may be a physical storage medium such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the systems and/or modules may be implemented or provided in other manners, such as at least partially in firmware and/or hardware, including, but not limited to, one or more application-specific integrated circuits (ASICs), discrete circuitry, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof. For example, in some embodiments a BCIP may be implemented using one or more application-specific integrated circuits (ASICs), discrete circuitry, standard integrated circuits, controllers (e.g., by executing appropriate instructions, and including microcontrollers and/or embedded controllers), field-programmable gate arrays (FPGAs), complex programmable logic devices (CPLDs), etc. In some embodiments, some of the modules or controllers separately described herein may be combined, split into further modules and/or split and recombined in various manners.

The various embodiments described above can be combined to provide further embodiments. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
encrypting or decrypting a binary data stream by,
applying a cryptographic function using a secret key to a data block to generate an encryption input block;
logically combining bits of the encryption input block to generate a binary encryption stream, wherein the encryption input block in not determinable solely from the binary encryption stream; and
applying a reversible logic operation to combine each bit of the binary data stream with a bit of the binary encryption stream.

2. The method of claim 1, comprising generating a successive encryption input block by applying the cryptographic function to the encryption input block previously obtained.

3. The method of claim 2 wherein the generation of the binary encryption stream is done in cycles during each of which several bits of the binary encryption stream are generated, the generation of encryption input blocks having a duration equal to at least twenty generation cycles of the binary encryption stream.

4. The method of claim 1 wherein an initial data block is:
randomly generated;
used to generate a first data block by application of the cryptographic function; and
transmitted by a data stream emitter to a data stream receiver.

5. The method of claim 1 wherein the generation of the binary encryption stream is done in cycles, each comprising combining several bits of the encryption input block to generate several bits of the binary encryption stream, and of updating a part of the encryption input block by combining several bits of the encryption input block, wherein after a number of cycles, each bit of the encryption input block depends from all the bits of an initial encryption input block.

6. The method of claim 1 wherein the cryptographic function is selected from one of an advanced encryption standard (AES), a data encryption standard (DES), a Triple DES, a Twofish function, a Serpent function, and a hashing function, applied to the data block and to the secret key.

7. A device, comprising:
an encryption binary stream generator having:
an encryption block generator configured to generate an encryption input block from a data block using a secret key; and
combinational logic configured to generate a binary encryption stream from bits of the encryption input block, wherein the encryption input block is not determinable solely from the binary encryption stream; and
logic configured to combine bits of the binary encryption stream with respective bits of a binary data stream.

8. The device of claim 7 wherein the logic configured to combine bits of the binary encryption stream with respective bits of the binary data stream is configured to:
in a first mode of operation, encrypt the binary data stream; and
in a second mode of operation, decrypt the binary data stream.

9. The device of claim 7 wherein the combinational logic comprises supply logic configured to generate bits of the binary encryption stream as a function of bits of the encryption input block, and update logic configured to combine bits of the encryption input block and to replace bits of the encryption input block with bits resulting from the combination.

10. The device of claim 9 wherein the update logic is configured so that after a number of processing cycles of the update logic, each bit of an updated encryption input block depends on all the bits of the encryption input block supplied by the encryption block generator.

11. The device of claim 7 wherein the combinational logic comprises:
a block shift register configured to shift the encryption input block at each processing cycle of the combinational logic a number of bits equal to a number of bits of the binary encryption stream supplied at each processing cycle of the combinational logic; and
logic gates configured to generate bits of the binary encryption stream by combining several output bits of the shift register.

12. The device of claim 7 wherein the combinational logic comprises:
a block shift register configured to shift the encryption input block at each processing cycle of the combinational logic a number of bits equal to a number of bits of the binary encryption stream supplied at each processing cycle of the combinational logic; and
non-linear logic configured to combine output bits of the block shift register and to introduce bits obtained by the non-linear logic in the block shift register.

13. The device of claim 12 wherein the non-linear logic comprises:
a plurality of word shift registers configured to shift bits in words output by the block shift register;
a plurality of logic blocks each coupled to a plurality of outputs of the plurality of word shift registers; and
logic configured to combine outputs of the plurality of logic blocks to generate an output word that is introduced in the block shift register.

14. The device of claim 7 wherein the combinational logic is configured to supply bits of the binary encryption stream at each of the cycles of a clock signal driving the combinational logic.

15. The device of claim 7 wherein the combinational logic comprises a block shift register configured to shift the encryption input block at each of cycle of a clock signal driving the combinational logic, the combinational logic being configured to update at least a part of the block shift register at each cycle of the clock signal.

16. A system, comprising:
a plurality of devices, each having:
a encryption block generator configured to generate an encryption input block from a data block using a secret key;
combinational logic configured to generate a binary encryption stream from bits of the encryption input block, wherein the encryption input block is not determinable solely from the binary encryption stream; and
logic configured to combine bits of the binary encryption stream with respective bits of a binary data stream; and
a data link configured to communicatively couple the plurality of devices.

17. The system of claim 16 wherein the combinational logic comprises an encryption input block shift register.

18. The system of claim 16 wherein the logic configured to combine bits of the binary encryption stream with respective bits of the binary data stream is configured to:
in a first mode of operation, encrypt the binary data stream; and
in a second mode of operation, decrypt the binary data stream.

19. A device, comprising:
means for generating an encryption input block from a data block;
means for generating a binary encryption stream from the encryption input block so that the encryption input block in not determinable solely from the binary encryption stream; and
means for combining each bit of a binary data stream with a bit of the binary encryption stream.

20. The device of claim 19, comprising means for generating successive encryption input blocks from an encryption input block previously obtained.

21. The device of claim 19 wherein the means for generating the encryption input block is configured to apply to the data block a cryptographic function selected from one of an advanced encryption standard (AES), a data encryption standard (DES), a Triple DES, a Twofish function, a Serpent function, and a hashing function.
